(19) United States
(12) Patent Application Publication
(10) Pub. No.: US 2006/0177115 A1
(43) Pub. Date: Aug. 10, 2006

(54) Medical image processing apparatus and program

(75) Inventors: Hiroshi Fujita, Aisai-shi (JP); Ryujiro Yokoyama, Hashima-gun (JP); Satoshi Kasai, Tokyo (JP)

Correspondence Address: LUCAS & MERCANTI, LLP, 475 PARK AVENUE SOUTH, 15TH FLOOR, NEW YORK, NY, 10016, US

(73) Assignees: GIFU UNIVERSITY; Konica Minolta Medical & Graphic, Inc.

(21) Appl. No.: 11/194,928

(22) Filed: Aug. 2, 2005

(30) Foreign Application Priority Data
Feb. 4, 2005 (JP) 2005-029125

(51) Int. Cl. G06K 9/00

(52) U.S. Cl. 382/128; 382/181

(57) ABSTRACT

A medical image processing apparatus includes: a primary candidate detection section for detecting a primary candidate for an abnormal shadow based on one medial image taken under one of a plurality of imaging conditions, by using medical images taken under the plurality of imaging conditions when an image analysis of the medical images is performed to detect an abnormal shadow candidate from the medical images; a false positive candidate detection section for detecting a false positive candidate in the primary candidate based on location information of the detected primary candidate by using another medical image taken under another imaging condition; and a judgment section for judging a candidate obtained by removing the false positive candidate from the detected primary candidate as a final result of detecting the abnormal shadow candidate.

### BACKGROUND OF THE INVENTION

1. Field of the Invention

The present invention relates to a medical image processing apparatus performing an image analysis of a medical image and detecting a candidate region for an abnormal shadow.

2. Description of the Related Art

In a medical field, digitalization of medical images of patients is realized. At diagnosis, a doctor performs interpretation of digital medical image data displayed on a display and detects an abnormal shadow considered as a lesion. In recent years, for purposes of reducing a burden on the interpreting doctor and reducing missed abnormalities, medical image processing apparatus called computer aided diagnosis apparatus (hereinafter, referred to as CAD) performing image processing for medical images and automatically detecting abnormal shadow candidates have been developed.

Such CADs are disclosed in the following literatures:

Japanese Patent Laid-open Publication No. 2002-112986,

Hayashi Norio, et al., “A method of automatically extracting a cerebellum and an affected area in a head MRI image using morphology processing”, Journal of Medical Imaging and Information Sciences, vol 21. no 1. pp 109-115, 2004,

Calli C. et al., “DWI findings of periventricular ischemic changes in patients with leukoaraiosis”, Comput Med Imaging Graph, vol 27. no 5. pp 381-386, 2003.

The above CADs sometimes incorrectly judge shadows of normal tissue or benign lesions as abnormalities (hereinafter, the shadows incorrectly detected are referred to as false positive candidates). The appearance rate of false positive candidates varies depending on conditions for detecting the abnormal shadow candidates, and the conditions are relaxed in some cases when it is desired to detect every candidate that may be an abnormal shadow. In this case, the number of false positive candidates tends to be large. However, the doctor has to check all the detected abnormal shadow candidates, and the excessive false positive candidates cause complication.

The excessive false positive candidates which are detected as described above is due to detection of the candidate using only a single scanned image. In other words, information necessary for detecting the abnormal shadow candidates, which is obtained from the single scanned image, is limited, and detection accuracy is restricted.

### SUMMARY OF THE INVENTION

An object of the present invention is to reduce error detections of false positive candidates and increase the accuracy in detecting abnormal shadow candidates.

To achieve the above object, according to a first aspect of the present invention, a medical image processing apparatus comprises:

a primary candidate detection section for detecting a primary candidate for an abnormal shadow based on one medial image taken under one of a plurality of imaging conditions, by using medical images taken under the plurality of imaging conditions when an image analysis of the medical images is performed to detect an abnormal shadow candidate from the medical images;

a false positive candidate detection section for detecting a false positive candidate in the primary candidate based on location information of the detected primary candidate by using another medical image taken under another imaging condition; and

a judgment section for judging a candidate obtained by removing the false positive candidate from the detected primary candidate as a final result of detecting the abnormal shadow candidate.

According to the present invention, the abnormal shadow candidate can be detected by using the plurality of medical images taken under the different imaging conditions. In the case of detection of the abnormal shadow candidate using only one medical image, only information obtained from the one medical image can be used. However, by using the plurality of medical images like the present invention, much information can be obtained from the medical images, and the judgment of the abnormal shadow candidate can be performed based on the much information. Accordingly, the number of false positive candidates incorrectly detected can be reduced, and the accuracy in detecting the abnormal shadow candidate can be increased.

Preferably, the medical images taken under the plurality of imaging conditions are T1-weighted and T2-weighted images taken by a magnetic resonance imaging (MRI) apparatus.

According to the present invention, in an examination by the MRI apparatus, the T1-weighted and T2-weighted images, which are generally used by a doctor at diagnosis, can be also used for detecting the abnormal shadow. Accordingly, it is not required to separately take special images to detect an abnormal shadow candidate. It is possible to minimize a burden on the body being examined.

According to a second aspect of the present invention, a medical image processing apparatus comprises:

a primary candidate detection section for detecting a primary candidate for an abnormal shadow based on one medial image taken under one of a plurality of imaging conditions, by using medical images taken under the plurality of imaging conditions when an image analysis of the medical images is performed to detect an abnormal shadow candidate from the medical images;

a false positive candidate detection section for detecting a false positive candidate in the detected primary candidate based on location information of the primary candidate by using any one of the plurality of medical images including the medical image used for detecting the primary candidate; and

a judgment section for judging a candidate obtained by removing the false positive candidate from the detected primary candidate as a final result of detecting the abnormal shadow candidate.

According to the present invention, the false positive candidate can be detected by using the plurality of medical images taken under the different imaging conditions. In the case of detection of the abnormal shadow candidate using only one medical image, only information obtained from the one medical image can be used. However, by using the plurality of medical images like the present invention, much information can be obtained from the medical images, and the judgment of the abnormal shadow candidate can be performed based on the much information. Accordingly, the number of false positive candidates incorrectly detected can be reduced, and the accuracy in detecting the abnormal shadow candidate can be increased.

Preferably, the medical images taken under the plurality of imaging conditions are T1-weighted and T2-weighted images taken by a magnetic resonance imaging (MRI) apparatus.

According to the present invention, in an examination by the MRI apparatus, the T1-weighted and T2-weighted images, which are generally used by a doctor at diagnosis, can be also used for detecting the abnormal shadow. Accordingly, it is not required to separately take special images to detect an abnormal shadow candidate. It is possible to minimize a burden on the body being examined.

According to a third aspect of the present invention, a medical image processing apparatus comprises:

a primary candidate detection section for detecting a primary candidate for an abnormal shadow based on one medial image taken under one of a plurality of imaging conditions, by using medical images taken under the plurality of imaging conditions when an image analysis of the medical images is performed to detect an abnormal shadow candidate from the medical images;

a location specifying section for specifying a location corresponding to the detected primary candidate in a plurality of the medical images taken under the other imaging conditions;

a false positive candidate detection section for detecting a false positive candidate in the primary candidate based on the specified location by using the plurality of medical images taken under the other imaging conditions; and

a judgment section for judging a candidate obtained by removing the false positive candidate from the primary candidate as a final result of detecting the abnormal shadow candidate.

According to the present invention, the false positive candidate can be detected by using the plurality of medical images taken under the different imaging conditions. In the case of detection of the abnormal shadow candidate using only one medical image, only information obtained from the one medical image can be used. However, by using the plurality of medical images like the present invention, much information can be obtained from the medical images, and the judgment of the abnormal shadow candidate can be performed based on the much information. Accordingly, the number of false positive candidates incorrectly detected can be reduced, and the accuracy in detecting the abnormal shadow candidate can be increased. Moreover, in the detection of the false positive candidate, alignment can be carried out between one taken image and the taken images by the location of the primary candidate. This alignment allows the false positive candidate to be accurately detected in the other taken images, thus increasing the accuracy in detecting the false positive candidate.

Preferably, the medical images taken under the plurality of imaging conditions are T1-weighted and T2-weighted images taken by MRI apparatus.

According to a fourth aspect of the present invention, a program allows the computer to realize:

a function for detecting a primary candidate for an abnormal shadow based on one medial image taken under one of a plurality of imaging conditions, by using medical images taken under the plurality of imaging conditions when an image analysis of the medical images is performed to detect an abnormal shadow candidate from the medical images;

a function for detecting a false positive candidate in the primary candidate based on location information of the detected primary candidate by using another medical image taken under another imaging condition; and

a function for judging a candidate obtained by removing the false positive candidate from the detected primary candidate as a final result of detecting the abnormal shadow candidate.

According to the present invention, the abnormal shadow candidate can be detected by using the plurality of medical images taken under the different imaging conditions. In the case of detection of the abnormal shadow candidate using only one medical image, only information obtained from the one medical image can be used. However, by using the plurality of medical images like the present invention, much information can be obtained from the medical images, and the judgment of the abnormal shadow candidate can be performed based on the much information. Accordingly, the number of false positive candidates incorrectly detected can be reduced, and the accuracy in detecting the abnormal shadow candidate can be increased.

According to a fifth aspect of the present invention, a program allows the computer to realize:

a function for detecting a primary candidate for an abnormal shadow based on one medial image taken under one of a plurality of imaging conditions, by using medical images taken under the plurality of imaging conditions when an image analysis of the medical images is performed to detect an abnormal shadow candidate from the medical images;

a function for detecting a false positive candidate in the detected primary candidate based on location information of the primary candidate by using any one of the plurality of medical images including the medical image used for detecting the primary candidate; and

a function for judging a candidate obtained by removing the false positive candidate from the detected primary candidate as a final result of detecting the abnormal shadow candidate.

According to the present invention, the false positive candidate can be detected by using the plurality of medical images taken under the different imaging conditions. In the case of detection of the abnormal shadow candidate using only one medical image, only information obtained from the one medical image can be used. However, by using the plurality of medical images like the present invention, much information can be obtained from the medical images, and the judgment of the abnormal shadow candidate can be performed based on the much information. Accordingly, the number of false positive candidates incorrectly detected can be reduced, and the accuracy in detecting the abnormal shadow candidate can be increased.

According to a sixth aspect of the present invention, a program allows the computer to realize:

a function for detecting a primary candidate for an abnormal shadow based on one medial image taken under one of a plurality of imaging conditions, by using medical images taken under the plurality of imaging conditions when an image analysis of the medical images is performed to detect an abnormal shadow candidate from the medical images;

a function for specifying a location corresponding to the detected primary candidate in a plurality of the medical images taken under the other imaging conditions;

a function for detecting a false positive candidate in the primary candidate based on the specified location by using the plurality of medical images taken under the other imaging conditions; and

a function for judging a candidate obtained by removing the false positive candidate from the primary candidate as a final result of detecting the abnormal shadow candidate.

According to the present invention, the false positive candidate can be detected by using the plurality of medical images taken under the different imaging conditions. In the case of detection of the abnormal shadow candidate using only one medical image, only information obtained from the one medical image can be used. However, by using the plurality of medical images like the present invention, much information can be obtained from the medical images, and the judgment of the abnormal shadow candidate can be performed based on the much information. Accordingly, the number of false positive candidates incorrectly detected can be reduced, and the accuracy in detecting the abnormal shadow candidate can be increased. Moreover, in the detection of the false positive candidate, alignment can be carried out between one taken image and the taken images by the location of the primary candidate. This alignment allows the false positive candidate to be accurately detected in the other taken images, thus increasing the accuracy in detecting the false positive candidate.

### BRIEF DESCRIPTION OF THE DRAWINGS

The present invention will become more fully understood from the detailed description given hereinafter and the accompanying drawing given by way of illustration only, and thus are not intended as a definition of the limits of the present invention, and wherein:

FIG. 1 is a diagram showing an internal configuration of a medical image processing apparatus in this embodiment;

FIG. 2A is a view showing an example of a T2-weighted image;

FIG. 2B is a view showing an example of a T1-weighted image;

FIG. 3 is a flowchart showing a flow of abnormal shadow candidate detection processing;

FIG. 4 is a view showing an image example of a shadow of lacunar infarction located at the vicinity of a brain ventricle;

FIG. 5 is a view showing a brain parenchyma region extracted from the T1-weighted image;

FIG. 6 is a diagram showing an example of inner and outer circles used for calculating contrast between a region of a lacunar infarction shadow candidate and a peripheral region; and

FIG. 7 is a view showing a display example of a result of detecting lacunar infarction shadows.

### PREFERRED EMBODIMENT OF THE INVENTION

A description is given of an embodiment according to the present invention below with reference to the drawings.

In this embodiment, an example of detecting abnormal shadow candidates is described from medical images (hereinafter, referred to as MRI images) obtained by imaging with MRI apparatus.

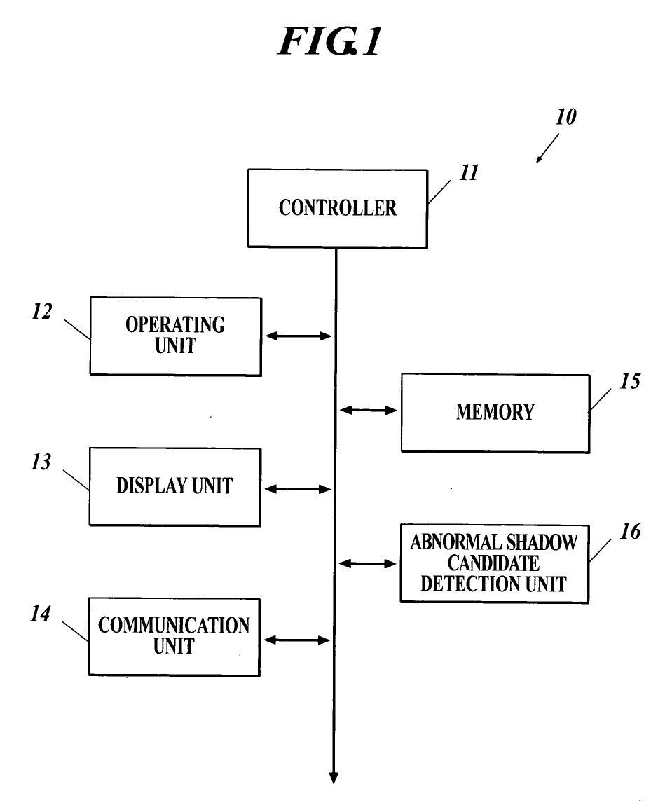

FIG. 1 shows an internal configuration of a medical image processing apparatus 10 in this embodiment.

As shown in FIG. 1, the medical image processing apparatus 10 includes a controller 11, an operating unit 12, a display unit 13, a communication unit 14, a memory 15, and an abnormal shadow candidate detection unit 16.

Next, a description is given of each member.

The controller 11 includes a central processing unit (CPU), a random access memory (RAM), and the like. The controller 11 reads various control programs from the memory 15 by means of the CPU and develops the same in the RAM for centralized control of operations of each member according to the control programs. For example, the controller 11 receives information of a result of detecting abnormal shadow candidates from the abnormal shadow candidate detection unit 16, generates screen data showing the detection result, and causes the display unit 13 to display the screen data.

The operation unit 12 includes a keyboard composed of cursor keys, numeric keys, and various function keys and a pointing device such as a mouse and a touch panel. The operation unit 12 generates an operation signal corresponding to a key pressed or a mouse operation and outputs the same to the controller 11.

The display unit 13 includes a liquid crystal display (LCD) or the like and, according to control by the controller 11, displays various display screens such as medical images, results of detecting the abnormal shadow candidates by the abnormal shadow candidate detection unit 16, and a screen for changing detection conditions.

The communication unit 14 includes a communication interface such as a network interface card, a modem, and a terminal adapter and receives scanned medical images from various types of imaging apparatus such as MRI apparatus and computed radiography (CR) apparatus connected through a LAN inside a hospital. The communication unit 1,4 may be connected to and receives the medical images from, not limited to the imaging apparatus, medical image generation apparatus such as a laser digitizer scanning a film having a medical image recorded thereon by means of laser light and reading the medical image and a film scanner reading a medical image recorded on a film by means of a sensor composed of a photoelectric transducer such as a charge coupled device (CCD). In addition, the communication unit 14 may be configured so as to be connected to a flat panel detector composed of a capacitor and a radiation detector generating charges according to intensity of irradiated radiation, and the like.

The way of inputting the medical images is not limited to communication. For example, it can be configured to provide an interface for connecting the medical image generation apparatus and input medical images generated in the above various types of medical image generation apparatus through the above interface into the medical image processing apparatus 10.

The medical image processing apparatus 10 may be configured to be connected to a terminal for interpretation placed in each examination room through the communication unit 14 and send the results of detecting the abnormal shadow candidates to the terminal.

The memory 15 stores the various control programs executed in the controller 11, an abnormal shadow candidate detection program executed in the abnormal shadow candidate detection unit 16, data processed by each program, parameters used in the abnormal shadow candidate detection program, and the like.

The abnormal shadow candidate detection unit 16 is an abnormal shadow candidate detection section of performing image analysis of medical images inputted through the communication unit 14 and detecting regions highly likely to be the abnormal shadow from the medical images as the abnormal shadow candidates.

The abnormal shadow candidate detection unit 16 includes a CPU, a RAM, and the like. The abnormal shadow candidate detection unit 16 reads the abnormal shadow candidate detection program from the memory 15 and executes the later-described abnormal shadow candidate detection process in cooperation with the program. The abnormal shadow candidate detection unit 16 thus carries out various operations to perform: detection of primary candidates for the abnormal shadow using one MRI image among a plurality of MRI images taken under different imaging conditions; specification of locations in the other MRI image corresponding to locations of the detected primary candidates; detection of the false positive candidates using the other MRI images; and the like and then sets the candidates remaining after removing the false positive candidates from the primary candidates as a final result of detecting the abnormal shadow candidates. In other words, the cooperation of the abnormal shadow candidate detection program and the abnormal shadow candidate detection unit 16 can implement a primary candidate detection section, a false positive candidate detection section, a location specifying section, and a judgment section.

Hereinafter, a description is given of the abnormal shadow candidate detection process executed by the abnormal shadow candidate detection unit 16 with reference to the drawing. In this embodiment, the description is given of an example of detecting abnormal shadow candidates (hereinafter, referred to as lacunar infarction shadow candidates) for lacunar infarction, which causes cerebral infarction, using T1-weighted and T2-weighted images which are MRI images of a head of a patient taken by the MRI apparatus under different imaging conditions. The lacunar infarction occurs when a blood flow in a thin blood vessel called a perforating artery in a brain stops and cells downstream become necrotic.

First, the T1-weighted and T2-weighted images used for the detection are described. The T1-weighted and T2-weighted images are general medical images used when a doctor makes a diagnosis of lacunar infarction, which are taken by the MRI apparatus.

The MRI is a technique to obtain an image utilizing nuclear magnetic resonance (hereinafter, referred to as NMR) in a magnetic field.

In the NMR, a body to be examined is put in a magnetostatic field and then is irradiated by radio waves having the resonant frequency of an atomic nucleus targeted for detection in the body being examined. Medical applications usually use the resonant frequency of a hydrogen atom constituting water highly included in a human body. When the body being examined is irradiated by radio waves, an excitation phenomenon occurs, and phases of nuclear spins of atoms resonating with the resonant frequency are aligned. Simultaneously, the nuclear spins absorb energy of the radio waves. When the irradiation of the radio waves is stopped in this excitation state, a relaxation phenomenon occurs, and the phases of the nuclear spins become misaligned while the nuclear spins release the energy. The time constant in terms of the phase relaxation is T1, and the time constant in terms of the energy relaxation is T2.

These values T1 and T2 affect the contrast of MRI images. Image signals of tissue having smaller T1 or larger T2 have higher signal intensity. An image taken under an imaging condition at a scan adjusted so that this T1 becomes small is the T1-weighted image, and an image taken under an imaging condition at a scan adjusted so that this T2 becomes large is the T2-weighted image.

Each human body tissue includes specific T1 and T2 values, and a combination of the T1-weighted and T2-weighted images allows specification of the tissue. Generally, with the T1-weighted image, an anatomic structure can be easily recognized. In the T2-weighted image, many types of lesions appear white. The T2-weighted image is therefore often used for detecting lesions.

As for brain tissue, the T1-weighted image includes higher signals (whiter and less dense in the image) in the order of: fat>brain white matter>brain gray matter>water (cerebrospinal fluid or the like). On the contrary, the T2-weighted image includes lower signals (blacker and denser in the image) in the above order.

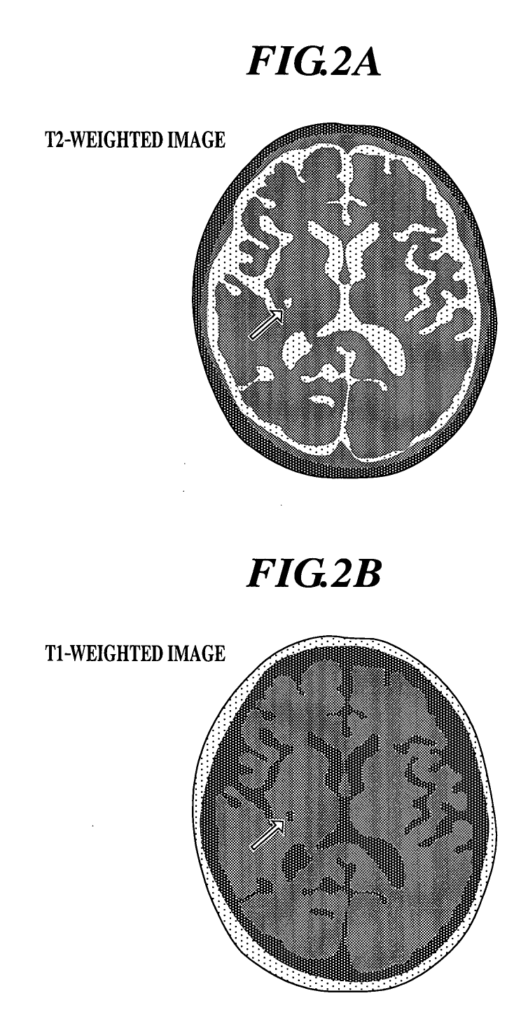

As shown in examples of the T1-weighted and T2-weighted images in FIGS. 2A and 2B, a brain parenchyma region (indicating a part of the brain (within a pia mater) other than a ventricle, which is of white and gray matters in a cerebellum and a cerebrum including a brain stem and a basal ganglion) includes high signals and appears white in the T2-weighted image while including low intensity signals and appearing black in the T1-weighted image. On the other hand, since lacunar infarction is an edema containing water, the lacunar infarction provides high signals in the T2-weighted image (low density region indicated by an arrow in FIG. 2A) and provides low signals in the T1-weighted image (high density region indicated by an arrow in FIG. 2B). Moreover, lacunar infarction is located at the periphery of the brain ventricle in the brain parenchyma region and appears as a circular shadow in the image at intensity different from that of the peripheral region thereof.

Next, a description is given of the abnormal shadow candidate detection process to detect candidate regions for the lacunar infarction shadow using the T1-weighted and T2-weighted images in the abnormal shadow candidate detection unit 16. Parameters used in the process, such as threshold values, are properly read from the memory 15 for use.

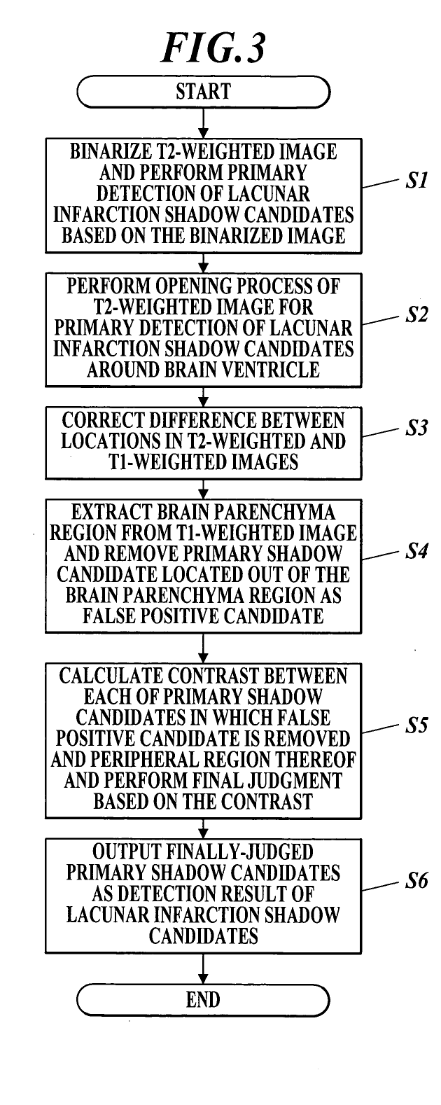

In the abnormal shadow candidate detection process shown in FIG. 3, first, the T2-weighted image is binarized, and then primary detection of the lacunar infarction shadow candidates from the binarized images is performed (step S1). Generally, disease stages of lacunar infarction are separated into an acute stage, a subacute stage, and a chronic stage, and pixel values of the MRI image vary depending on the stages. The pixel values also vary depending on differences in the imaging conditions. The binarization of the T2-weighted image is therefore performed with the threshold value varied by increments of 10 in a range of, for example, −45 to +25 around an average pixel value of the brain ventricle region.

In the binarized images, the lacunar infarction shadow is expected to have a circular shape with a diameter of about 3 to 10 mm. Moreover, it is expected that the pixel values within the region are 0 while the pixel values in the brain parenchyma region therearound are 1. Accordingly, regions having such a characteristic density property are detected, and then image characteristic values (hereinafter, referred to as just characteristic values) such as circularity and area of the detected regions are calculated. Using the calculated characteristic values, the primary detection of the lacunar infarction shadow candidates is performed by a characteristic value analysis, such as discriminant analysis, using an actual lacunar infarction shadow as sample data.

The above process is performed for each binarized image obtained with each threshold value. Based on the center of gravity of each candidate detected in each binarized image, the lacunar infarction shadow candidates detected within a certain range from the center of gravity more than once are set as the primary candidates.

Subsequently, the T2-weighted image is subjected to an opening process for primary detection of the lacunar infarction shadow candidates located on the periphery of the brain ventricle, which are not detected in the step S1 (step S2).

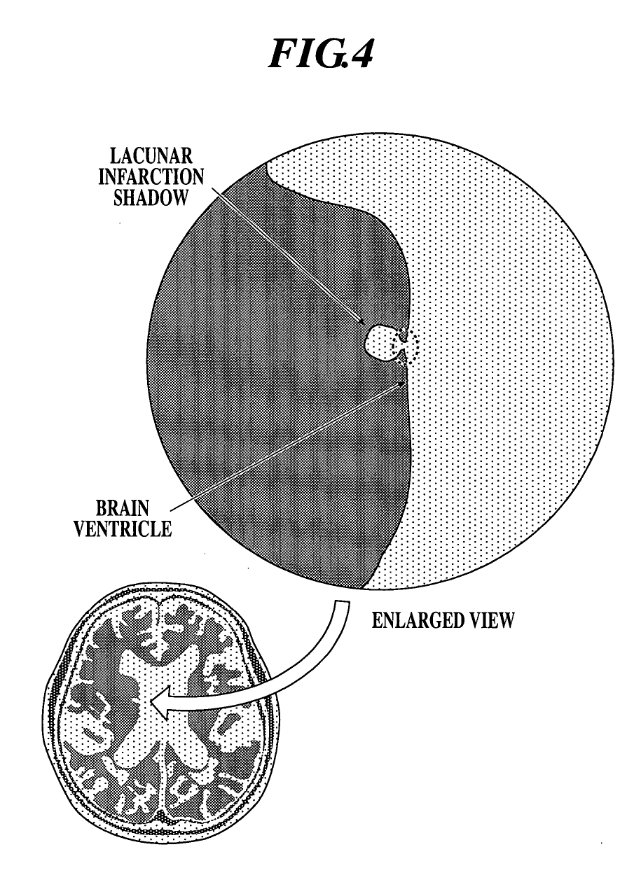

The lacunar infarction shadows are often located on the periphery of the brain ventricle. When lacunar infarction is located in adjacent to the brain ventricle, as shown in FIG. 4, the image of the lacunar infarction shadow sometimes appears partially merged with the image of the brain ventricle since the brain ventricle has low density on the T2-weighted image similar to the lacunar infarction shadow. In such a case, the lacunar infarction shadow is treated as a part of the brain ventricle and is difficult to detect by the detection method of the step S1. Accordingly, the detection of the lacunar infarction shadow candidates is performed after the region of the lacunar infarction shadow part of which protrudes from the brain ventricle is separated from the region of the brain ventricle by the opening process.

Specifically, difference between images of circles with radii of 1 and 8 subjected to the opening process is calculated, and the characteristic value analysis is then performed to detect the lacunar infarction shadow candidate.

The detected lacunar infarction shadow candidate is added to the primary candidates detected in the step S1.

After the primary candidates are detected as described above, the difference in positions between the T2-weighted and T1-weighted images is corrected based on location information of the detected primary candidates (step S3).

As for the lacunar infarction, necrotic cells and cells affected by the same are both imaged on the T2-weighted image with low density while information of only the necrotic cells is mainly imaged on the T1-weighted image. Accordingly, lacunar infarction shadows appearing in the T1-weighted and T2-weighted images are different from each other in size and shape in many cases, and the centers of gravity thereof also do not match in many cases. In the region of each primary candidate detected on the T2-weighted image, the center of a 3×3 pixel having a minimum average pixel value in the region of 13×13 pixels is calculated. The position of the calculated center is specified as the center of the gravity of the primary candidate in the T1-weighted image. The difference in positions between the T2-weighted and T1-weighted images is thus corrected.

After the difference in positions is corrected, the brain parenchyma region is extracted from the T1-weighted image. The primary candidates located in the brain parenchyma region are then detected as the false positive candidates and removed from the primary candidates (step S4). The brain parenchyma region is extracted by a region growing method with a most-frequent density value set as a region growing seed point which is calculated based on a density histogram obtained from the T1-weighted image. FIG. 5 shows an example of the extracted brain parenchyma region. In FIG. 5, a black-colored region is the brain parenchyma region. Since a lacunar infarction shadow is located in the brain parenchyma region, the primary candidates detected in regions other than the extracted brain parenchyma region, including cerebral sulci and a limbic part, can be judged as the false positive candidates. Based on the positions of the centers of gravity of the primary candidates set in the T1-weighted image in the step S3, the false positive candidates located out of the brain parenchyma region are therefore detected from the primary candidates and removed from the primary candidates.

Subsequently, the contrast between the region of each primary candidate and the peripheral region thereof is calculated in the T1-weighted image, and a final judgment is carried out based oh the calculated contrast whether the primary candidate is the lacunar infarction shadow candidate (step S5). As previously described, in the T1-weighted image, the brain parenchyma region has slightly high density, and the lacunar infarction shadow has higher density than that of the brain parenchyma region. In detecting lacunar infarction, the doctor usually relatively observes the contrast between a region thought to be lacunar infarction and the peripheral region thereof and discriminates whether the region thought to be lacunar infarction is especially different from the peripheral region.

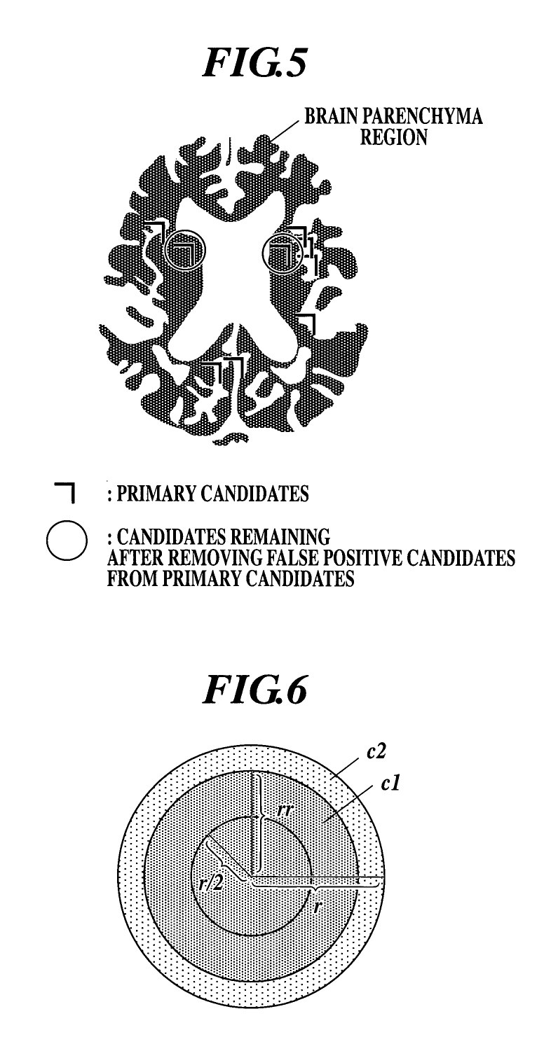

As shown in FIG. 6, two types of circles, which are an inner circle C1 representing the region of the lacunar infarction shadow and an outer circle C2 representing the peripheral region thereof, are calculated based on the center of gravity and area of the region of each primary candidate. The difference between the average pixel values in the inner circle region and in a region obtained by subtracting the inner circle region from the outer circle region is calculated as the contrast. When the contrast is not less than a threshold value, the primary candidate is finally judged as the lacunar infarction shadow region. The threshold concerning the contrast is experimentally obtained in advance and stored in the memory 15. In the process, the contrast is read from the memory 15.

The finally judged primary candidates are outputted to the controller 11 as the result of detecting the lacunar infarction shadow candidates (step S6).

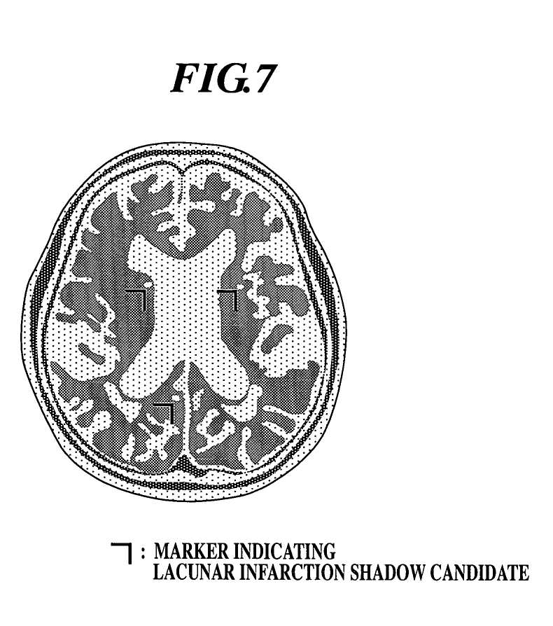

In the controller 11, upon reception of the result of detecting the lacunar infarction shadow candidates from the abnormal shadow candidate detection unit 16, as shown in FIG. 7, marker images indicating the detected lacunar infarction shadow candidates are synthesized with the T2-weighted image. The synthesized image is displayed on the display unit 13 by means of the control of the controller 11.

The doctor can check the location, shape, and the like of the regions thought to be the lacunar infarction shadow candidates by observation of the T2-weighted image with the detection result displayed as shown in FIG. 7.

As described above, according to the embodiment, the lacunar infarction shadow candidates are detected using a plurality of MRI images (T1-weigted and T2-weighted images) taken under different imaging conditions. In the case of performing detection using only one MRI image, only information obtained from the one MRI image can be utilized for the detection. However, like this embodiment, using a plurality of MRI images, a lot of information can be obtained from the images, and the judgment of the lacunar infract shadows can be performed based on the lot of information. Accordingly, the number of false positive candidates incorrectly detected can be reduced, and the accuracy in detecting the lacunar infarction shadow candidates can be increased.

Moreover, the detection uses the T2-weighted image effective for extracting lesions, and normal tissue is extracted using the T1-weighted image effective for extracting anatomic structures. The false positive candidates are then removed. Accordingly, the accuracy in detecting the lacunar infarction shadow candidates can be expected to considerably increase.

In this embodiment, the primary candidates are detected by the T2-weighted image, and the false positive candidates are detected by the T1-weighted image and removed from the primary candidates. The two-step judgment structure, in which the false positive candidates incorrectly detected at the primary detection are removed, can further increase the detection accuracy.

The plurality of medical images used for detecting the lacunar infarction shadow candidates are the T1-weighted and T2-weighted images generally taken at MRI diagnosis, which removes the need for separately taking a special image for the detection process by the medical image processing apparatus 10. Accordingly, it is possible to minimize the burden on a patient as the body being examined. Moreover, the detection is performed using the same image as the doctor uses for diagnosis, and the doctor can compare the detection result by the medical image processing apparatus 10 with the doctor's diagnosis.

Furthermore, the T1-weighted and T2-weighted images are aligned based on the positions of the centers of gravity of the primary candidates detected from the T2-weighted image. This alignment allows accurate specification of the location of each primary candidate, thus increasing the accuracy in detecting the false positive candidates. The false positive candidates can be accurately removed from the primary candidates, and the false detection rate can be reduced.

The aforementioned medical image processing apparatus 10 is just a preferable example to which the present invention is applied.

For example, in the aforementioned embodiment, the medical image processing apparatus 10 includes the display unit 13 and is configured to cause the display unit 13 to display the results of detecting the lacunar infarction shadow candidates. However, the medical image processing apparatus 10 may not include the display unit 13 and may be configured to perform only the process to detect the lacunar infarction shadow candidates and send the detection results to the other apparatuses such as a terminal for interpretation.

Moreover, a FLAIR image may be used instead of the T1-weighted and T2-weighted images.

Furthermore, in the above description, the candidates are detected using a piece of the T1-weighted image and a piece of the T2-weighted image. However, the detection may be performed, not limited to this, using a plurality of the T1-weighted images and a plurality of the T2-weighted images, which are taken with the imaging conditions varied to have different parameter values T1 and T2. In this case, the primary detection is performed for each of the plurality of T2-weighted images, and the false positive candidates are extracted using the plurality of T1-weighted images from the primary candidates commonly detected from every image. This can increase the detection accuracy in the primary detection and the accuracy in detecting the false positive candidates, and the combination thereof can increase the accuracy in detecting the lacunar infarction shadow candidates.

In the aforementioned embodiment, the description is given of the example of detecting the lacunar infarction shadow candidates from the MRI images of a head, but the present invention can be applied to detection of other abnormal shadow candidates concerning to another part. For example, in the case of detecting tumor shadows and minute calcified clusters, which are findings of breast cancer, from a X-ray image (this is called a mammography) obtained by imaging breasts by means of the CR apparatus, a plurality of X-ray images with different imaging conditions are taken. The primary detection for the tumor shadows and the like is performed for each of the plurality of X-ray images. The false positive candidates may be detected using any one of the X-ray images and removed from the primary candidates detected from the X-ray images more than once. Moreover, the false positive candidates may be detected using any one of the plurality of X-ray images including the X-ray images used for the primary detection.

Furthermore, in the case of the mammography, image qualities of obtained scanned images vary depending on X-ray tube voltage, a mAs value, an additional filter type, an X-ray tube type, and an imaging apparatus type. Accordingly, it is possible to use a plurality of medical images taken with these imaging conditions varied.

The entire disclosure of a Japanese Patent Application No. 2005-29125, filed on Feb. 4, 2005, including specifications, claims, drawings and summaries are incorporated herein by reference in their entirety.

What is claimed is:

1. A medical image processing apparatus comprising:
a primary candidate detection section for detecting a primary candidate for an abnormal shadow based on one medial image taken under one of a plurality of imaging conditions, by using medical images taken under the plurality of imaging conditions when an image analysis of the medical images is performed to detect an abnormal shadow candidate from the medical images;
a false positive candidate detection section for detecting a false positive candidate in the primary candidate based on location information of the detected primary candidate by using another medical image taken under another imaging condition; and
a judgment section for judging a candidate obtained by removing the false positive candidate from the detected primary candidate as a final result of detecting the abnormal shadow candidate.

2. The apparatus of claim 1, wherein the medical images taken under the plurality of imaging conditions are T1-weighted and T2-weighted images taken by a magnetic resonance imaging apparatus.

3. A medical image processing apparatus comprising:
a primary candidate detection section for detecting a primary candidate for an abnormal shadow based on one medial image taken under one of a plurality of imaging conditions, by using medical images taken under the plurality of imaging conditions when an image analysis of the medical images is performed to detect an abnormal shadow candidate from the medical images;
a false positive candidate detection section for detecting a false positive candidate in the detected primary candidate based on location information of the primary candidate by using any one of the plurality of medical images including the medical image used for detecting the primary candidate; and
a judgment section for judging a candidate obtained by removing the false positive candidate from the detected primary candidate as a final result of detecting the abnormal shadow candidate.

4. The apparatus of claim 3, wherein the medical images taken under the plurality of imaging conditions are T1-weighted and T2-weighted images taken by a magnetic resonance imaging apparatus.

5. A medical image processing apparatus comprising:
a primary candidate detection section for detecting a primary candidate for an abnormal shadow based on one medial image taken under one of a plurality of imaging conditions, by using medical images taken under the plurality of imaging conditions when an image analysis of the medical images is performed to detect an abnormal shadow candidate from the medical images;
a location specifying section for specifying a location corresponding to the detected primary candidate in a plurality of the medical images taken under the other imaging conditions;
a false positive candidate detection section for detecting a false positive candidate in the primary candidate based on the specified location by using the plurality of medical images taken under the other imaging conditions; and
a judgment section for judging a candidate obtained by removing the false positive candidate from the primary candidate as a final result of detecting the abnormal shadow candidate.

6. The apparatus of claim 5, wherein the medical images taken under the plurality of imaging conditions are T1-weighted and T2-weighted images taken by a magnetic resonance imaging apparatus.

7. A program allowing the computer to realize:
a function for detecting a primary candidate for an abnormal shadow based on one medial image taken under one of a plurality of imaging conditions, by using medical images taken under the plurality of imaging conditions when an image analysis of the medical images is performed to detect an abnormal shadow candidate from the medical images;
a function for detecting a false positive candidate in the primary candidate based on location information of the detected primary candidate by using another medical image taken under another imaging condition; and
a function for judging a candidate obtained by removing the false positive candidate from the detected primary candidate as a final result of detecting the abnormal shadow candidate.

8. A program allowing the computer to realize:
a function for detecting a primary candidate for an abnormal shadow based on one medial image taken under one of a plurality of imaging conditions, by using medical images taken under the plurality of imaging conditions when an image analysis of the medical images is performed to detect an abnormal shadow candidate from the medical images;
a function for detecting a false positive candidate in the detected primary candidate based on location information of the primary candidate by using any one of the plurality of medical images including the medical image used for detecting the primary candidate; and
a function for judging a candidate obtained by removing the false positive candidate from the detected primary candidate as a final result of detecting the abnormal shadow candidate.

9. A program allowing the computer to realize:
a function for detecting a primary candidate for an abnormal shadow based on one medial image taken under one of a plurality of imaging conditions, by using medical images taken under the plurality of imaging conditions when an image analysis of the medical images is performed to detect an abnormal shadow candidate from the medical images;
a function for specifying a location corresponding to the detected primary candidate in a plurality of the medical images taken under the other imaging conditions;
a function for detecting a false positive candidate in the primary candidate based on the specified location by using the plurality of medical images taken under the other imaging conditions; and
a function for judging a candidate obtained by removing the false positive candidate from the primary candidate as a final result of detecting the abnormal shadow candidate.
